(19) United States
(12) Patent Application Publication
(10) Pub. No.: US 2014/0223026 A1
(43) Pub. Date: Aug. 7, 2014

(54) FLOW CONTROL MECHANISM FOR A STORAGE SERVER

(71) Applicant: INTEL CORPORATION, Santa Clara, CA (US)

(72) Inventors: Eliezer Tamir, Bait Shemesh (IL); Phil C. Cayton, Portland, OR (US); Ben-Zion Friedman, Jerusalem (IL); Robert O. Sharp, Round Rock, TX (US); Donald E. Wood, Austin, TX (US); Vadim Makhervaks, Austin, TX (US)

(21) Appl. No.: 13/993,525

(22) PCT Filed: Jan. 10, 2012
(86) PCT No.: PCT/US2012/020720

§ 371 Date: Jun. 12, 2013

(51) Int. Cl. H04L 12/801

(52) U.S. Cl. CPC H04L 47/39
USPC 709/235

(57) ABSTRACT

Generally, this disclosure relates to a method of flow control. The method may include determining a server load in response to a request from a client; selecting a type of credit based at least in part on server load; and sending a credit to the client based at least in part on server load, wherein server load corresponds to a utilization level of a server and wherein the credit corresponds to an amount of data that may be transferred between the server and the client and the credit is configured to decrease over time if the credit is unused by the client.

### FIELD The present disclosure relates to a flow control mechanism for storage servers.

### BACKGROUND

A storage network typically includes a plurality of networked storage devices coupled to or integral with a server. Remote clients may be configured to access one or more of the storage devices via the server. Examples of storage networks include, but are not limited to, storage area networks (SANs) and network-attached storage (NAS).

A plurality of clients may establish connections with the server in order to access one or more of the storage devices. Flow control may be utilized to ensure that the server has sufficient resources to service all of the requests. For example a server might be limited by the amount of available RAM needed to buffer incoming requests. In this case, a well-designed server should not allow simultaneous requests that require more than the total available buffers. Examples of flow control include, but are not limited to, rate control and credit-based schemes. In a credit-based scheme, a client may be provided a credit from the server when the client establishes a connection with the server.

For example, in a Fiber Channel network protocol, the credit is exchanged between devices (e.g., client and server) at log-in. The credit corresponds to a number of frames that may be transferred between the client and the server. Once the credit has run out (i.e., been used up), a source device may not send new frames until the destination device has indicated that it is able to process outstanding received frames and is ready to receive the new frames. The destination device signals that it is ready by notifying the source device (i.e., the client) that it has more credit. Processed frames or sequences of frames may then be acknowledged, indicating that the destination device is ready to receive more frames. In another example, in the iSCSI network protocol, a target (e.g., server) may regulate flow via TCP's congestion window mechanism.

A drawback of existing credit-based schemes is that credit, once granted to a connected client, remains available to that client until it is used. This may result in more outstanding credits among connected clients than the server can service. Thus, if a number of clients utilize their credit at the same time, the server may not have the internal resources needed to service all of them. Another drawback of existing credit-based schemes is that the flow control schemes remain static. Servers may adjust to greater client connections or increased traffic by either dropping frames or decreasing future credit grants. Thus, simple credit-based schemes may not cope well with large numbers of connected clients that have a “bursty” utilization pattern.

### BRIEF DESCRIPTION OF DRAWINGS

Features and advantages of the claimed subject matter will be apparent from the following detailed description of embodiments consistent therewith, which description should be considered with reference to the accompanying drawings, wherein:

FIG. 1 illustrates one exemplary system embodiment consistent with the present disclosure;

FIG. 2 is an exemplary flow chart illustrating operations of a server consistent with the present disclosure;

FIG. 3A is an exemplary client finite state machine for an embodiment consistent with the present disclosure;

FIG. 3B is an exemplary server finite state machine for an embodiment consistent with the present disclosure;

FIG. 4A is an exemplary flow chart illustrating operations of a client for an embodiment consistent with the present disclosure;

FIG. 4B is an exemplary flow chart illustrating operations of a server configured for dynamic flow control consistent with the present disclosure;

FIG. 5 is an exemplary server finite state machine for another embodiment consistent with the present disclosure; and

FIG. 6 is an exemplary flow chart of operations of a server for the embodiment illustrated in FIG. 5.

Although the following Detailed Description will proceed with reference being made to illustrative embodiments, many alternatives, modifications, and variations thereof will be apparent to those skilled in the art.

### DETAILED DESCRIPTION

Generally, this disclosure relates to a flow control mechanism for a storage server. A method and system are configured to provide credits to clients and to respond to transaction requests from clients based on a flow control policy. A credit corresponds to an amount of data that may be transferred between the client and server. A type of credit selected and a timing of a response (e.g., when credits are sent) may be based at least in part on the flow control policy. The flow control policy may change dynamically based on a number of connected clients and/or a server load. Server load corresponds to a utilization level of the server and includes any server resource, e.g., RAM buffer capacity, CPU load, storage device bandwidth, and/or other server resources. Server load depends on server capacity and an amount of requests for service and/or transactions the server is processing. If the amount exceeds capacity, the server is overloaded (i.e., congested). The number of connected clients and server load may be evaluated in response to receiving a request, in response to fulfilling a request and/or part of a request, in response to a connection being established between the server and a client and/or prior to sending a credit to the client. Thus, the flow control policy may change dynamically based on server load and/or the number of connected clients. The particular policy applied to a client may be transparent to the client, enabling server flexibility.

Credit types may include, but are not limited to, decay, command only, and command and data. A decay credit may decay over time and/or may expire. Thus, an outstanding unused decay credit may become unavailable after a predetermined time interval. Load predictability may be increased since a relatively large number of previously idle clients may not overwhelm a busy server with a sudden burst of requests.

Traffic between the server and a client typically includes both commands and data. In an embodiment consistent with the present disclosure, commands may include data descriptors configured to identify data associated with the command. In this embodiment, the server may be configured to drop the data and retain the command, based on flow control policy. The server may then retrieve the data using the descriptors from the command when the policy permits. For example, when the server is too busy to service a request, the server may place the command in a queue and drop the data. When the server load decreases, the server may retrieve the data and execute the queued command. Not storing the data allows the commands to be stored in the queue since commands typically occupy about one to three orders of magnitude less space than data occupy.

Thus, there is herein described a variety of flow control options where a particular option is selected by the server based on a flow control policy. The policy may be based at least in part on server load and/or the number of connected clients. The policy is configured to be transparent to the client and may be implemented/executed dynamically based on instantaneous server load. Although the flow control mechanism is described herein related to a storage server, the flow control mechanism is similarly applicable to any type of server, without departing from the scope of the present disclosure.

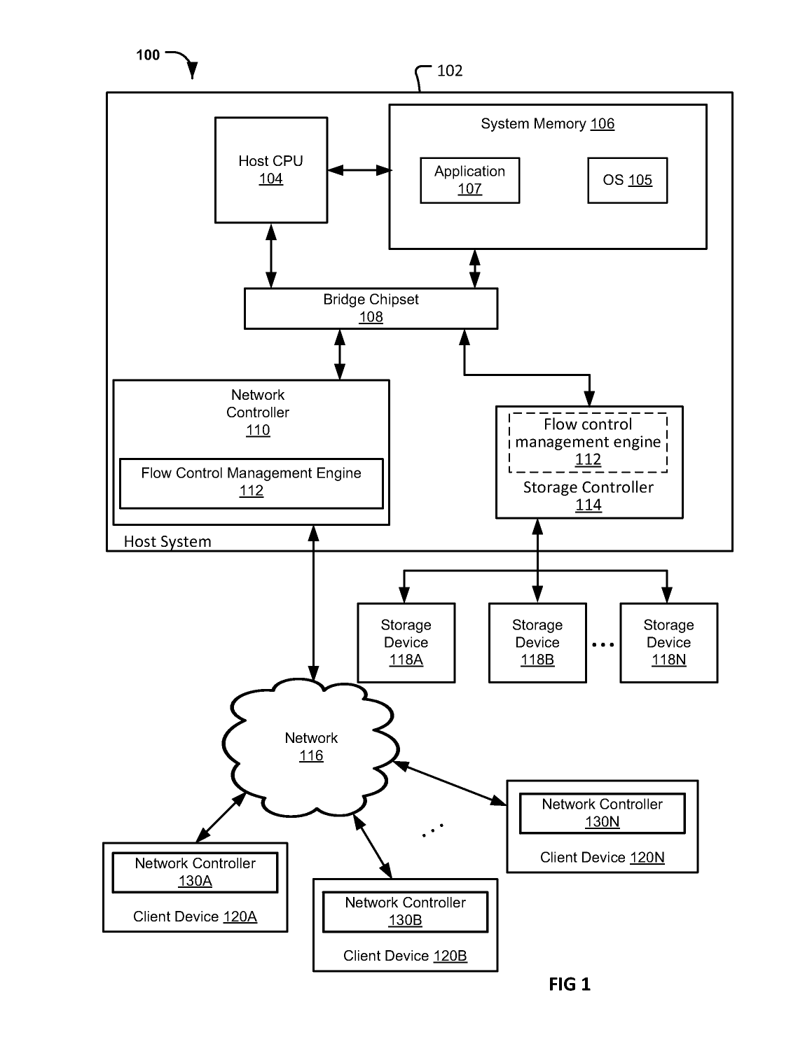

FIG. 1 illustrates one exemplary system embodiment consistent with the present disclosure. System 100 generally includes a host system 102 (server), a network 116, a plurality of storage devices 118A, 118B, . . . , 118N and a plurality of client devices 120A, 120B, . . . , 120N. Each client device 120A, 120B, . . . , 120N may include a respective network controller 130A, 130B, . . . , 130N configured to provide network 116 access to the client device 120A, 120B, . . . , 120N. The host system 102 may be configured to receive request(s) from one or more client devices 120A, 120B, . . . , 120N for access to one or more storage devices 118A, 118B, . . . , 118N and may be configured to respond to the request(s) as described herein.

The host system 102 generally includes a host processor “host CPU” 104, a system memory 106, a bridge chipset 108, a network controller 110 and a storage controller 114. The host CPU 104 is coupled to the system memory 106 and the bridge chipset 108. The system memory 106 is configured to store an operating system OS 105 and an application 107. The network controller 110 is configured to manage transmission and reception of messages between the host 102 and client devices 120A, 120B, . . . , 120N. The bridge chipset 108 is coupled to the system memory 106, the network controller 110 and the storage controller 114. The storage controller 114 is coupled to the network controller 110 via the bridge chipset 108. The bridge chipset 108 may provide peer to peer connectivity between the storage controller 114 and the network controller 110. In some embodiments, the network controller 110 and the storage controller 114 may be integrated. The network controller 110 is configured to provide the host system 102 with network connectivity.

The storage controller 114 is coupled to one or more storage devices 118A, 118B, . . . , 118N. The storage controller 114 is configured to store data to (write) and retrieve data from (read) the storage device(s) 118A, 118B, . . . , 118N. The data may be stored/retrieved in response to a request from client device(s) 120A, 120B, . . . , 120N and/or an application running on host CPU 104.

The network controller 110 and/or the storage controller 114 may include a flow control management engine 112 configured to implement a flow control policy as described herein. The flow control management engine 112 is configured to receive a credit request and/or a transaction request from one or more client device(s) 120A, 120B, . . . , 120N. A transaction request may include a read request or a write request. A read request is configured to cause the storage controller 114 to read data from one or more of the storage device(s) 118A, 118B, . . . , 118N and to provide the read data to the requesting client device 120A, 120B, . . . , 120N. A write request is configured to cause the storage controller 114 to write data received from the requesting client device 120A, 120B, . . . , 120N to storage device(s) 118A, 118B, . . . , 118N. The data may be read or written using remote direct memory access (RDMA). For example, communication protocols configured for RDMA include, but are not limited to, InfiniBand™ and iWARP.

The flow control management engine 112 may be implemented in hardware, software and/or a combination of both. For example, software may be configured to calculate and to allocate a credit and hardware may be configured to enforce the credit.

In credit-based flow control, a client may send a transaction request only when the client has outstanding unused credits. If the client does not have unused credits, the client may request a credit from the server and then send the transaction request once credit(s) are received from the server. A credit corresponds to an amount of data that may be transferred between the client and server. Thus, the amount of data transferred is based, at least in part, on the amount of outstanding unused credit. For example, a credit may correspond to a line rate multiplied by server processing latency. Such a credit is configured to allow a client to fully utilize the line when no other clients are active. A credit may correspond to a number of frames and/or an amount of data that may be transferred. A client may receive credit(s) in response to sending the credit request to the server, in response to establishing a connection with a server and/or in response to a transaction between client and server. The credits are configured to provide flow control.

In an embodiment consistent with the present disclosure, a plurality of credit types may be used by the server to implement a dynamic flow control policy. Credit types include, but are not limited to, decay, command only, and command and data. An amount of data associated with a decay credit may decrease (“decay”) over time from an initial value when the credit is issued to zero when the decay credit expires. A rate at which the decay credit decreases may be based on one or more decay parameters. The decay parameters include a decay time interval, a decay amount, and an expiration interval. The decay parameters may be selected by the server when the credit is issued, based at least in part on flow control policy. For example, decay parameters may be selected based at least in part on a number of active connected clients.

A decay credit may be configured to decrease by the decay amount at the end of a time period corresponding to the decay time interval. For example, the decay amount may correspond to a percentage (e.g., 50%) of the outstanding credit amount at the end of each time interval or may correspond to a number of bytes and/or frames of data. In another example, the decay amount may correspond to a percentage (e.g., 10%) of the initially issued credit amount.

A decay credit may be configured to expire at the end of a time period corresponding to the expiration interval. For example, the expiration interval may correspond to a number of decay intervals. In another example, the expiration interval may not correspond to a number of decay intervals.

Once a decay credit is issued, both the server and the client may be configured to decrease the decay credit by the decay amount at the end of a time period (e.g., when a timer times out) corresponding to the decay time interval. Thus, a server may issue decay credits based on flow control policy configured to limit total available credits at all times. Outstanding decay credits may then decay if they are not used avoiding a situation where a number of clients that had been dormant initiate transaction requests that may then overwhelm the server.

Command only credits and command and data credits may be utilized where commands (and/or control) and data may be provided separately. This separation may allow the server to drop the data but retain the command when the server is congested (i.e., resources below a threshold). The server may then use descriptors in the command to retrieve the data at a later time. Thus, the commands include descriptors configured to allow the server to retrieve the appropriate data based on the descriptors. Whether the server drops the data is based, at least in part, on the flow control policy, the server load and/or the number of connected clients when the credits are issued. Command credits (i.e., to retrieve data later) may be issued when the server is relatively more congested and command and data credits may be issued when the server is relatively less congested.

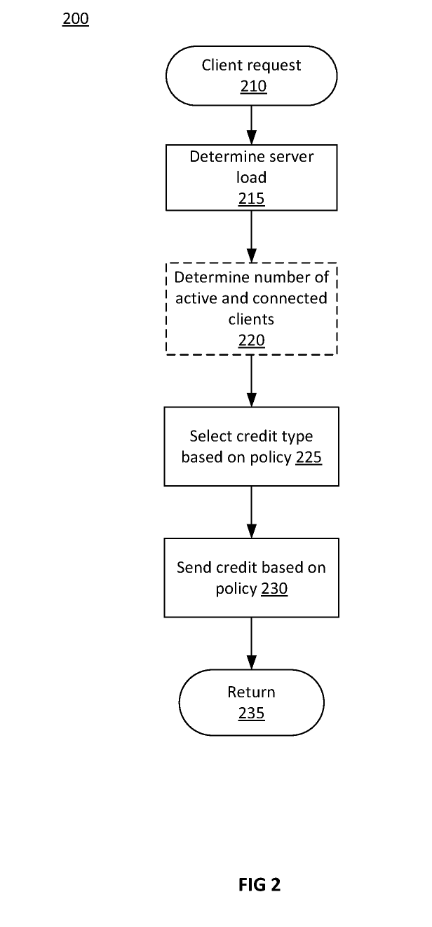

FIG. 2 is an exemplary flow chart 200 illustrating operations of a server for embodiments consistent with the present disclosure. The operations of flow chart 200 may be performed, for example, by server 102 (e.g., flow control management engine 112) of FIG. 1. For example, the operations of flow chart 200 may be initiated in response to a request for credit from a client, in response to a request to establish a connection between the server and a client (and the connection being established) and/or in response to a transaction request from a client. Flow may begin at operation 210. Operation 215 may include determining a server load. In some situations, a number of active and connected clients may be determined at operation 220. A credit type may be selected based on policy at operation 225. For example, credit type may correspond to a decay credit, a command only credit and/or a command and data credit, as described herein. The credit type selected may be based, at least in part, on the server load and/or the number of active and connected clients. Operation 230 may include sending the credit (of the selected credit type) based on the policy. For example, depending on server load, the credit may be sent upon receipt of a transaction request from a client or may be sent upon completion of the associated transaction. Program flow may end at operation 235.

Thus, the operations of flow chart 200 are configured to select a type of credit (e.g., decay credit) and/or the timing of providing the credit based on a flow control policy. The flow control policy is based, at least in part on server load and may be based on the number of active and connected clients. Server load and the number of active and connected clients are dynamic parameters that may change over time. In this manner, server load may be managed dynamically and bursts of data from a plurality of previously dormant clients may be avoided.

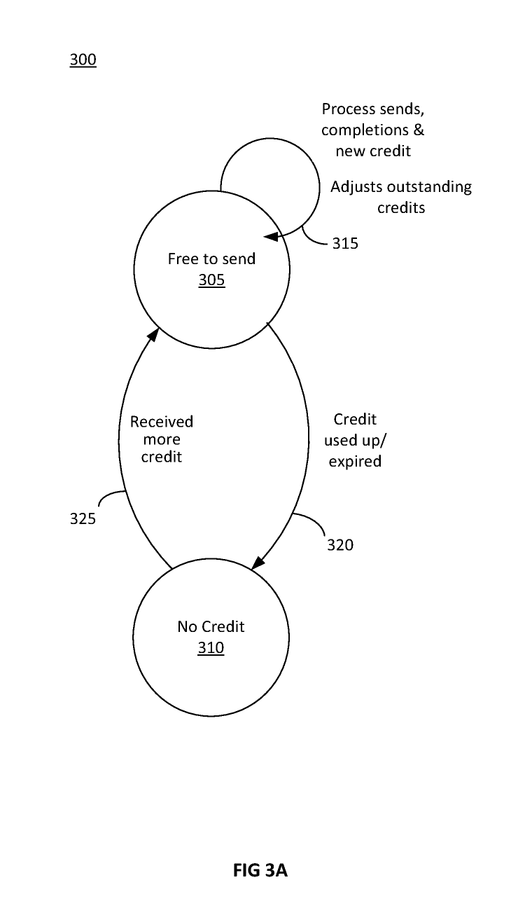

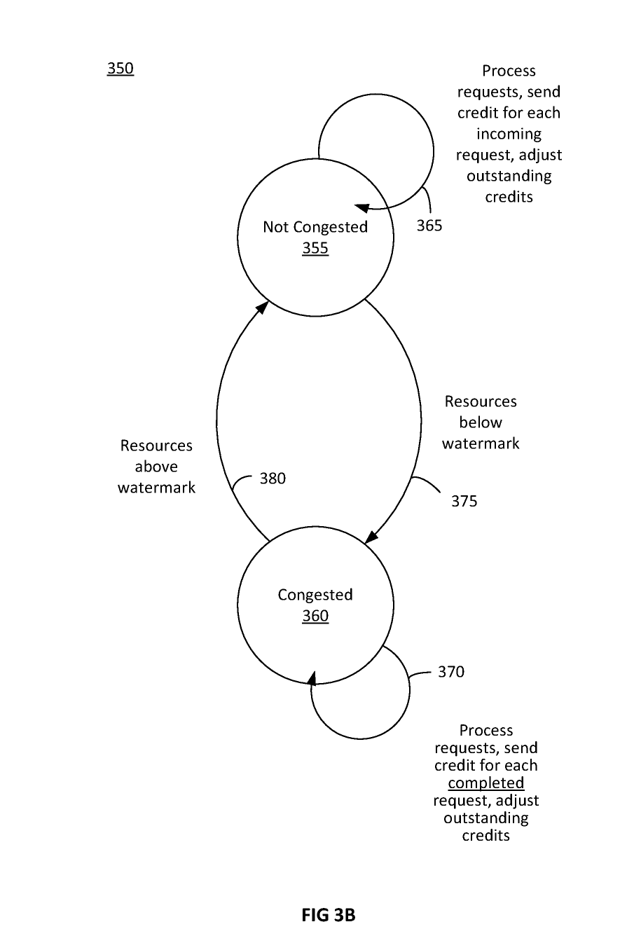

FIG. 3A is an exemplary client finite state machine 300 for an embodiment consistent with the present disclosure. In this embodiment, outstanding credits may decay over time and/or may expire. The client state machine 300 includes two states: free to send 305 and no credit 310. In the free to send state 305, the client has outstanding unused credits that have not expired. In the no credit state 310, the client may have used up previously provided credits (e.g., through transactions with a server) and/or previously provided credits may include decay credits that have expired. While in the free to send state 305, the client may be configured to process sends (i.e., send transaction requests, credit requests, commands and or data to the server) and to process completions (e.g., of data reads or writes). The client may be further configured to adjust outstanding credits (e.g., decay credits) using decay parameters and/or a local timer. The adjustment is configured to reduce the amount of outstanding unused credit as described herein. The client may transition from the free to send state 305 to the no credit state 310 when previously provided credit has been used up and/or has expired. The client may transition from the no credit state 310 to the free to send state 305 upon receipt of more credit.

Thus, a client may transition from a free to send state 305 to a no credit state 310 by using outstanding credits and/or upon the expiration of unused outstanding credits. A rate at which outstanding credits expire may be selected by the server based on the flow control policy. For example, the flow control policy may be configured to limit an amount of unused outstanding credits available to clients connected to the server.

FIG. 3B is an exemplary server finite state machine 350 for an embodiment consistent with the present disclosure. In this embodiment, outstanding credits may decay over time and/or may expire and timing of sending credits may be based on instantaneous server load. The server finite state machine 350 includes a first state 355 and a second state 360. The first state (not congested) 355 corresponds to the server having adequate resources available for its current load and number of active connected clients. The second state (congested) 360 corresponds to the server not having adequate resources available for its current load and number of active connected clients.

While in the not congested state 355, the server is configured to process requests (e.g., transaction requests and/or credit requests from clients) and to send credits in response to each incoming request (transaction or credit). The server may be further configured to adjust outstanding credits (e.g., decay credits) for each client that has outstanding decay credits using associated decay parameters and/or a local timer. While in the congested state 370, the server is configured to process requests from clients but rather than sending credits in response to each incoming request, the server is configured to send credits for each completed request. In this manner, credits may be provided to clients based, at least in part, on server load as server load may affect the timing of the completions and therefore the time when new credits are sent. The server may be further configured to adjust outstanding credits, similar to the not congested state 355.

The server may transition from the not congested state 355 to the congested state 360 in response to available server resources dropping 375 below a watermark. The server may transition from the congested state 360 to the not congested state 355 in response to available server resources rising above a watermark 380. Watermark represents a threshold related to server capacity such that available resources above the watermark correspond to the server not congested state 355 and server available resources below the watermark corresponds to the server congested state 360. Thus, the exemplary server finite state machine 350 of FIG. 3B illustrates an example of sending credits (upon receipt of an incoming request or upon completion) based on a flow control policy based on server load. Outstanding decay credits may also be adjusted in both the congested state 360 and the not congested state 355.

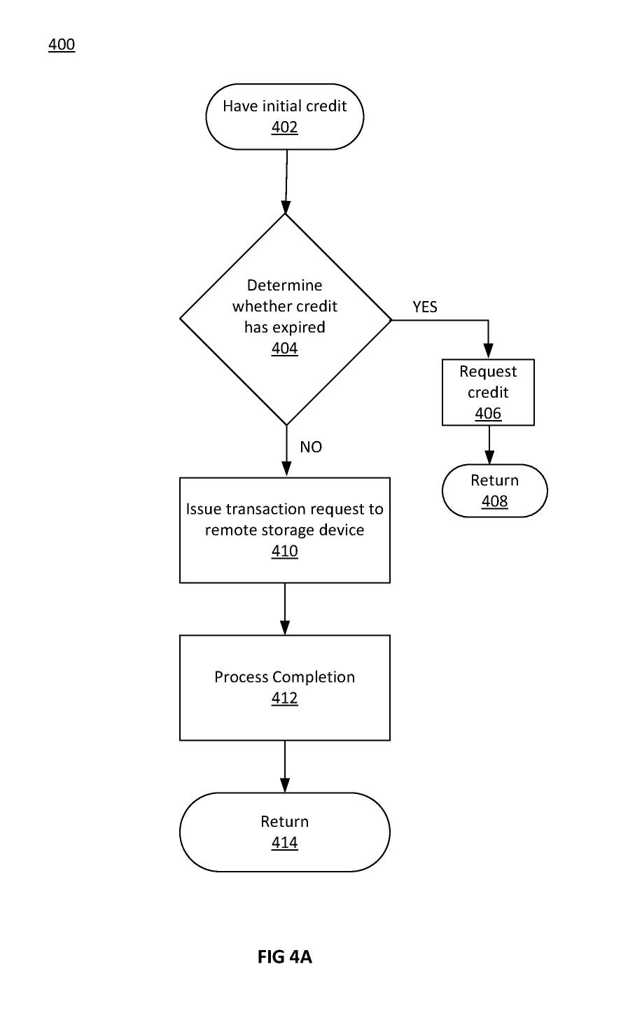

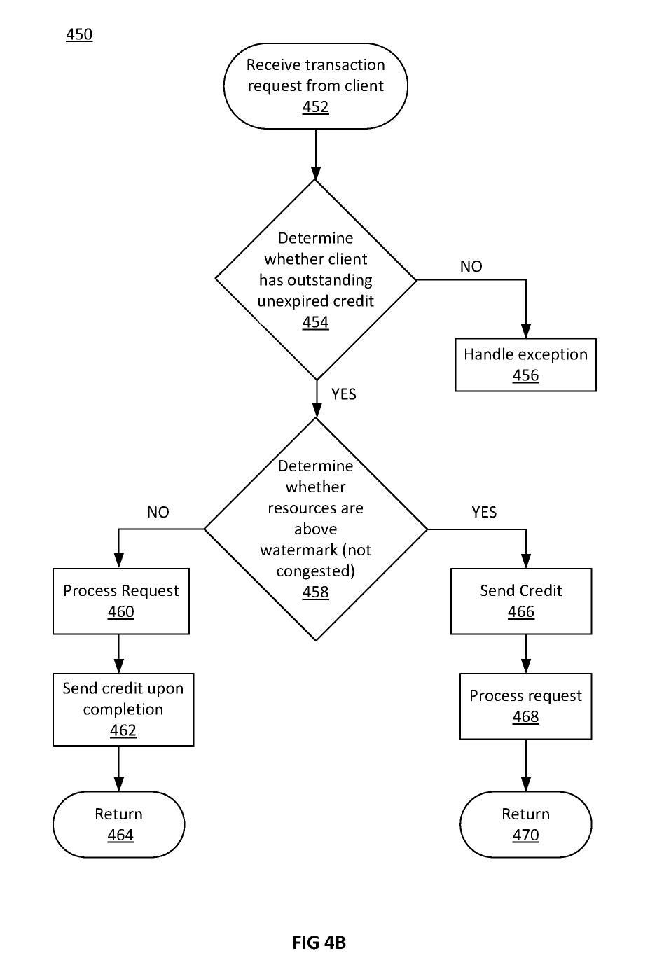

FIG. 4A is an exemplary flow chart 400 illustrating operations of a client for an embodiment consistent with the present disclosure. In this embodiment, outstanding credits may decay over time and/or may expire. The operations of flow chart 400 may be performed by one or more client device(s) 120A, 120B, . . . , 120N of FIG. 1. Flow may begin at operation 402 with the client having initial credit. Operation 404 may include determining whether the credit has expired. For example, an outstanding unused decay credit may have decayed to zero. In this example, a time period between issuance of the decay credit and operation 404 may have been long enough to allow the decay credit to decay to zero. In another example, the outstanding unused decay credit may have expired. In this example, a time period between issuance of the decay credit and the time when operation 404 is performed may be greater than or equal to the expiration interval, as described herein.

If the credit has expired, a credit request may be sent to the server at operation 406. Flow may then return at operation 408. If the credit has not expired, a transaction request may be sent to a remote storage device at operation 410. For example, the transaction may be a request. RDMA may be used to communicate the request. Operation 412 may include processing a completion. The completion may be received from the remote storage device when the data associated with the transaction request has been successfully transferred. Flow may then return at operation 414.

FIG. 4B is an exemplary flow chart 450 illustrating operations of a server configured for dynamic flow control consistent with the present disclosure. For example, the operations of flow chart 450 may be performed by server 102 of FIG. 1. Flow may begin at operation 452 when a transaction request is received from a client. The transaction request may be an RDMA transaction (e.g., read or write) request. Whether the client has outstanding unexpired credit may be determined at operation 454. For example, whether an outstanding, unused decay credit has decayed to zero and/or whether an expiration interval has run since issuance of the associated decay credit may be determined If the client does not have outstanding unexpired credit, an exception may be handled at operation 456.

If the client has outstanding unexpired credit, whether server available resources are above a watermark may be determined at operation 458. Server available resources being above a watermark (i.e., threshold) corresponds to a not congested state. If server resources are above the watermark, a credit may be sent at operation 466. The received transaction request may then be processed at operation 468. For example, data may be retrieved from a storage device and provided to the requesting client via RDMA. In another example, data may be retrieved from the requesting client and written to a storage device. Flow may end at operation 470 return. If server available resources are not above the watermark, the transaction request may be processed at operation 460. Operation 462 may include sending credit upon completion. Flow may end at operation 464 return.

Thus, flow control using decay credits may prevent a client from using outstanding unused credits after a specified time interval thereby limiting total available credit at any point in time. Further, credits issued in response to a transaction request may be sent to the requesting client upon receipt of the request or after completing the transaction associated with the request, based on policy that is based, at least in part, on server load (e.g., resource level). The policy being used may be transparent to the client. As illustrated by flow chart 400, for example, whether a client may issue a transaction request depends on whether the client has outstanding unused credit. The client may be unaware of the policy used by the server in granting a credit. In this embodiment, the server may determine when to send a credit based on instantaneous server load. Delaying sending credits to the client may result in a decreased rate of transaction requests from the client, thus implementing flow control based on server load.

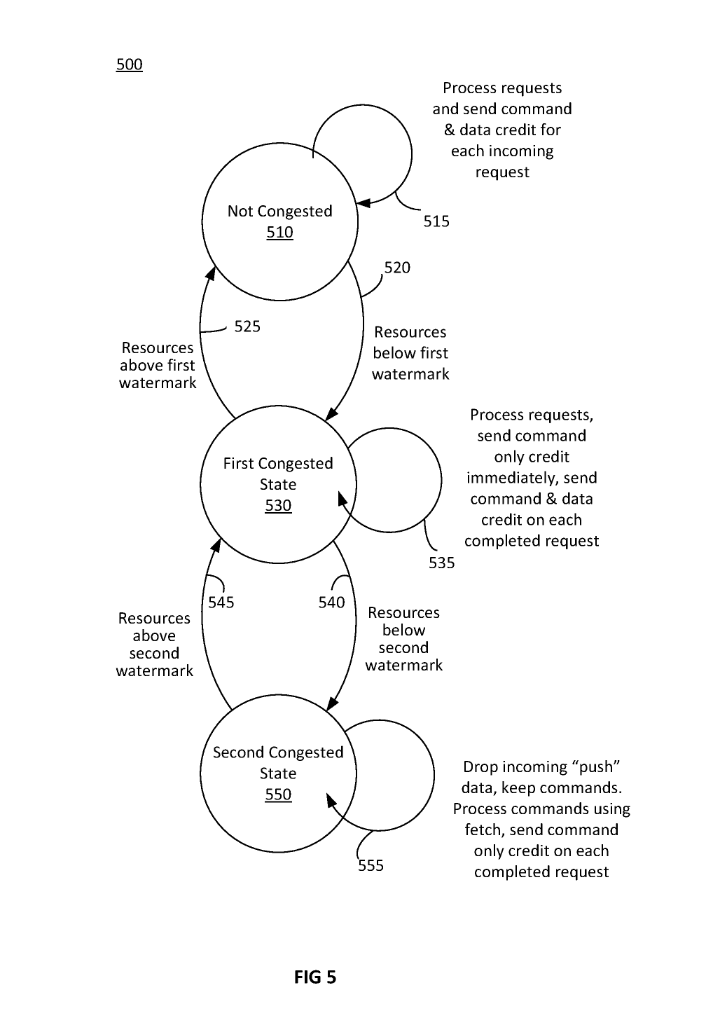

FIG. 5 is an exemplary server finite state machine 500 for another embodiment consistent with the present disclosure. In this embodiment, commands and data may be sent separately. Sending commands and data separately may provide the server relatively more flexibility in responding to client transaction requests when the server is congested. For example, when the server is congested the server may drop data and retain commands for later processing. The retained command may thus include data descriptors configured to allow the server to fetch the data when processing the command. In another example, when the server is relatively less congested, command only credits may be sent prior to command and data credits being sent.

The server state machine 500 includes three states. A first state (not congested) 510 corresponds to the server having adequate resources available for its current load and number of active connected clients. A second state (first congested state) 530 corresponds to the server being moderately congested. Moderately congested corresponds to server resources below a first watermark and above a second watermark (the second watermark below the first watermark). A third state (second congested state) 550 corresponds to the server being more than moderately congested. The second congested state 550 corresponds to server resources below the second watermark.

While in the not congested state 510, the server is configured to process requests (e.g., transaction requests and/or credit requests from clients) and to send a command and data credit in response to each received request. While in the not congested state 510, a single client may be able to utilize a full capacity of a server, e.g., at a line rate. While in the first congested state 530, the server is configured to process requests from clients, to send a command only credit in response to the received request and to send a command and data credit for each completed request. In this manner, when the server is in the first congested state 530, command only credits and command and data credits may be provided to clients based, at least in part, on server load.

While in the second congested state 550, the server is configured to drop incoming (“push”) data and to retain associated commands. The server is further configured to process the commands and to fetch data (using, e.g., data descriptors) as the associated command is processed. The server may then send a command only credit upon completion of each request. Thus, when the server is in the second congested state 550, incoming data may be dropped and may be later fetched when the associated command is processed, providing greater server flexibility. Further, the timing of providing credits to a client may be based, at least in part, on server load.

The server may transition from the not congested state 510 to the first congested state 530 in response to available server resources dropping below a first watermark 520 and may transition from the first congested state 530 to the not congested state 510 in response to available server resources rising above the first watermark 525. The server may transition from the first congested state 530 to the second congested state 550 in response to available server resources dropping below a second watermark 540. The second watermark corresponds to fewer available server resources than the first watermark. The server may transition from the second congested state 550 to the first congested state 530 in response to the available server resources rising to above the second watermark 545 (and below the first watermark).

Thus, the server finite state machine 500 is configured to provide flexibility to the server in selecting its response to a transaction request from a client. In this embodiment, commands and data may be transferred separately allowing dropping of the data and sending command only credits when the server is more than moderately congested. When the server is moderately congested, data may not be dropped, a command only credit may be sent upon receipt of a request and a command and data credit may be sent upon completion of a transaction associated with the request. The data may be later fetched when its associated command is being processed. Further, command only credit and command and data credit may be provided to a client with a timing based, at least in part, on server load.

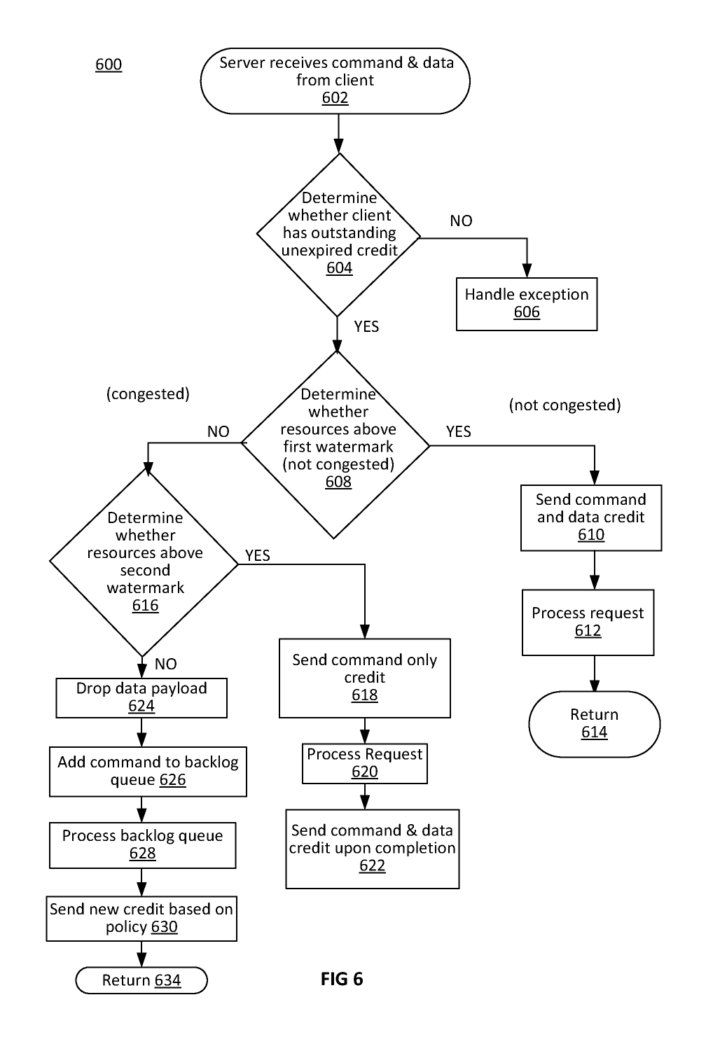

FIG. 6 is an exemplary flow chart 600 of operations of a server for the finite state machine illustrated in FIG. 5. For example, the operations of flow chart 600 may be performed by server 102 of FIG. 1. The operations of flow chart 600 may begin 602 when a command and data are received from a client. For example, the command may be an RDMA command. Whether the client has outstanding unexpired credit may be determined at operation 604.

Operation 606 includes handling the exception, if the client does not have outstanding unexpired credits. Whether server resources are above the first watermark may be determined at operation 608. Resources above the first watermark corresponds to the server being not congested. If the server is not congested, a command and data credit may be sent at operation 610. The request may be processed at operation 612 and flow may end at return 614.

If the server resources are below the first watermark, whether server resources are above the second watermark may be determined at operation 616. Server resources below the first watermark and above the second watermark correspond to the first congested state 530 of FIG. 5. If the server is in the first congested state, a command only credit may be sent at operation 618. The received request may be processed at operation 620. Operation 622 may include sending a command and data credit upon completion of the data transfer associated with the received request.

If resources are below the second watermark (i.e., the server is in the second congested state that is more congested than the first congested state), data payload may be dropped at operation 624. The command associated with the dropped data may be added to a command queue at operation 626. Operation 628 may include processing a command backlog queue (as server resources permit). New credit (i.e., command and/or data) may be sent according to flow control policy at operation 630. Flow may return at operation 634.

Thus, in this embodiment (command and data separate), command only credits and command and data credits may be provided at different times, based on server policy that is based, at least in part, on server instantaneous load. Further, when the server is in the second congested state (relatively more congested), data may be dropped and the associated command retained to be processed at a later time. The associated command may be placed in a command queue for processing when resources are available. Data may then be fetched when the associated command is processed.

A variety of flow control mechanisms have been described herein. Decay credits may be utilized to limit the number of outstanding credits. A server may be configured to send credits based, at least in part, on instantaneous server load. When the server is not congested, credits may be sent in response to a request, when the request is received. When the server is congested, credits may not be sent when the request is received but may be delayed until a data transfer associated with the request completes. For the embodiment with separate command and data, command only credits and command and data credits may be sent at different times, based, at least in part, on server load. If congestion worsens, incoming data may be dropped and its associated command may be stored in a queue for later processing. When the associated command is processed, the data may be fetched. Thus, the server may select a particular flow control mechanism or combination of mechanisms, dynamically, based in instantaneous server load and/or a number of active and connected clients.

While the foregoing is prided as exemplary system architectures and methodologies, modifications to the present disclosure are possible. For example, an operating system 105 in host system memory may manage system resources and control tasks that are run on, e.g., host system 102. For example, OS 105 may be implemented using Microsoft Windows, HP-UX, Linux, or UNIX, although other operating systems may be used. In one embodiment, OS 105 shown in FIG. 1 may be replaced by a virtual machine which may provide a layer of abstraction for underlying hardware to various operating systems running on one or more processing units.

Operating system 105 may implement one or more protocol stacks. A protocol stack may execute one or more programs to process packets. An example of a protocol stack is a TCP/IP (Transport Control Protocol/Internet Protocol) protocol stack comprising one or more programs for handling (e.g., processing or generating) packets to transmit and/or receive over a network. A protocol stack may alternatively be comprised on a dedicated sub-system such as, for example, a TCP offload engine and/or network controller 110.

Other modifications are possible. For example, system memory, e.g., system memory 106 and/or memory associated with the network controller, e.g., network controller 110, may comprise one or more of the following types of memory: semiconductor firmware memory, programmable memory, non-volatile memory, read only memory, electrically programmable memory, random access memory, flash memory, magnetic disk memory, and/or optical disk memory. Either additionally or alternatively system memory 106 and/or memory associated with network controller 110 may comprise other and/or later-developed types of computer-readable memory.

Embodiments of the methods described herein may be implemented in a system that includes one or more storage mediums having stored thereon, individually or in combination, instructions that when executed by one or more processors perform the methods. Here, the processor may include, for example, a processing unit and/or programmable circuitry in the network controller. Thus, it is intended that operations according to the methods described herein may be distributed across a plurality of physical devices, such as processing structures at several different physical locations. The storage medium may include any type of tangible medium, for example, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of media suitable for storing electronic instructions. The Ethernet communications protocol may be capable permitting communication using a

Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard”, published in March, 2002 and/or later versions of this standard.

The InfiniBand™ communications protocol may comply or be compatible with the InfiniBand specification published by the InfiniBand Trade Association (IBTA), titled “InfiniBand Architecture Specification”, published in June, 2001, and/or later versions of this specification.

The iWARP communications protocol may comply or be compatible with the iWARP standard developed by the RDMA Consortium and maintained and published by the Internet Engineering Task Force (IETF), titled “RDMA over Transmission Control Protocol (TCP) standard”, published in 2007 and/or later versions of this standard.

“Circuitry”, as used in any embodiment herein, may comprise, for example, singly or in any combination, hardwired circuitry, programmable circuitry, state machine circuitry, and/or firmware that stores instructions executed by programmable circuitry.

In one aspect there is provided a method of flow control. The method includes determining a server load in response to a request from a client; selecting a type of credit based at least in part on server load; and sending a credit to the client based at least in part on server load, wherein server load corresponds to a utilization level of a server and wherein the credit corresponds to an amount of data that may be transferred between the server and the client and the credit is configured to decrease over time if the credit is unused by the client.

In another aspect there is provided a storage system. The storage system includes a server and a plurality of storage devices. The server includes a flow control management engine, wherein the flow control management engine is configured to determine a server load in response to a request from a client for access to at least one of the plurality of storage devices, select a type of credit based at least in part on server load and to send a credit to the client based at least in part on server load, and wherein server load corresponds to a utilization level of the server and wherein the credit corresponds to an amount of data that may be transferred between the server and the client and the credit is configured to decrease over time if the credit is unused by the client.

In another aspect there is provided a system. The system includes one or more storage mediums having stored thereon, individually or in combination, instructions that when executed by one or more processors, results in the following: determining a server load in response to a request from a client; selecting a type of credit based at least in part on server load; and sending a credit to the client based at least in part on server load, wherein server load corresponds to a utilization level of a server and wherein the credit corresponds to an amount of data that may be transferred between the server and the client and the credit is configured to decrease over time if the credit is unused by the client.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

What is claimed is:

1. A method of flow control, the method comprising:
determining a server load in response to a request from a client;
selecting a type of credit based at least in part on server load; and
sending a credit to the client based at least in part on server load,
wherein server load corresponds to a utilization level of a server and wherein the credit corresponds to an amount of data that may be transferred between the server and the client and the credit is configured to decrease over time if the credit is unused by the client.

2. The method of claim 1 wherein the request comprises at least one of a connection request, a transaction request and a credit request.

3. The method of claim 1 wherein the credit is sent to the client upon receipt of the request by the server if the server load corresponds to server available resources being above a watermark or the credit is sent to the client upon completion of a transaction associated with the request if the server load corresponds to server resources being below the watermark.

4. The method of claim 1, further comprising decreasing the credit by a decay amount for each decay time interval that the credit is unused.

5. The method of claim 1 further comprising causing the credit to expire after an expiration interval if the credit is unused.

6. The method of claim 1 wherein the type of credit is selected based, at least in part, on a number of other clients connected to the server.

7. The method of claim 1 wherein a transaction between the server and the client comprises a command and associated data and the associated data is dropped if the server load corresponds to server available resources being below a watermark and the associated data is later retrieved when the server available resources increase to above the watermark.

8. A storage system comprising:
a server comprising a flow control management engine; and
a plurality of storage devices,
wherein the flow control management engine is configured to determine a server load in response to a request from a client for access to at least one of the plurality of storage devices, select a type of credit based at least in part on server load and to send a credit to the client based at least in part on server load, and wherein server load corresponds to a utilization level of the server and wherein the credit corresponds to an amount of data that may be transferred between the server and the client and the credit is configured to decrease over time if the credit is unused by the client.

9. The storage system of claim 8 wherein the request comprises at least one of a connection request, a transaction request and a credit request.

10. The storage system of claim 8, wherein the credit is sent to the client upon receipt of the request by the server if the server load corresponds to server available resources being above a watermark or the credit is sent to the client upon completion of a transaction associated with the request if the server load corresponds to server resources being below the watermark.

11. The storage system of claim 8 wherein the flow control management engine is further configured to decrease the credit by a decay amount for each decay time interval that the credit is unused.

12. The storage system of claim 8 wherein the flow control management engine is further configured to cause the credit to expire after an expiration interval if the credit is unused.

13. The storage system of claim 8 wherein the type of credit is selected based, at least in part, on a number of other clients connected to the server.

14. The storage system of claim 8 wherein a transaction between the server and the client comprises a command and associated data and the associated data is dropped if the server load corresponds to server available resources being below a watermark and the associated data is later retrieved when the server available resources increase to above the watermark.

15. A system comprising one or more storage mediums having stored thereon, individually or in combination, instructions that when executed by one or more processors, results in the following:
determining a server load in response to a request from a client;
selecting a type of credit based at least in part on server load; and
sending a credit to the client based at least in part on server load,
wherein server load corresponds to a utilization level of a server and wherein the credit corresponds to an amount of data that may be transferred between the server and the client and the credit is configured to decrease over time if the credit is unused by the client.

16. The system of claim 15 wherein the request comprises at least one of a connection request, a transaction request and a credit request.

17. The system of claim 15 wherein the credit is sent to the client upon receipt of the request by the server if the server load corresponds to server available resources being above a watermark or the credit is sent to the client upon completion of a transaction associated with the request if the server load corresponds to server resources being below the watermark.

18. The system of claim 15 wherein the instructions that when executed by one or more processors results in the following additional operations comprising:
decreasing the credit by a decay amount for each decay time interval that the credit is unused.

19. The system of claim 15 wherein the type of credit is selected based, at least in part, on a number of other clients connected to the server.

20. The system of claim 15 wherein a transaction between the server and the client comprises a command and associated data and the associated data is dropped if the server load corresponds to server available resources being below a watermark and the associated data is later retrieved when the server available resources increase to above the watermark.
